(19) United States
(12) Patent Application Publication
(10) Pub. No.: US 2010/0331181 A1
(43) Pub. Date: Dec. 30, 2010

(54) Method for Protecting Cereals From Being Infected By Fungi

(75) Inventors: Ulf Groeger, Neuhofen (DE); Siegfried Strathmann, Limburgerhof (DE); Egon Haden, Ludwigshafen (DE); Michael Vonend, Bad Duerkheim (DE)

Correspondence Address: BRINKS, HOFER, GILSON & LIONE, P.O. BOX 110285, RESEARCH TRIANGLE PARK, NC, 27709, US

(73) Assignee: BASF SE, Ludwigshafen (DE)

(21) Appl. No.: 12/919,649

(22) PCT Filed: Feb. 27, 2009
(86) PCT No.: PCT/EP2009/052412

§ 371 Date: Aug. 26, 2010

(30) Foreign Application Priority Data
Feb. 28, 2008 (EP) 08152059.5

(51) Int. Cl. A01C 1/06; A01N 43/653

(52) U.S. Cl. 504/100; 514/383; 504/358

(57) ABSTRACT

Method for protecting cereals from being infected by harmful fungi, wherein the cereals, their seed or the soil is treated with a synergistically active combination comprising
a) bixafen (I) or N-[2-(1,3-dimethylbutyl)-phenyl]-1,3-dimethyl-5-fluor-1H-pyrazole-4-carboxamide (II) and
b) epoxiconazole or metconazole;
   a fungicidal agent and seed comprising said combination.

The invention relates to a method for protecting cereals from being infected by specific harmful fungi, wherein the cereal plants, their seed or the soil is treated with a fungicidally effective amount of a synergistically active combination comprising
a) bixafen (I) or N-[2-(1,3-dimethylbutyl)-phenyl]-1,3-dimethyl-5-fluor-1H-pyrazole-4-carboxamide (II) and
b) epoxiconazole or metconazole.

Bixafen (IUPAC name: N-(3′,4′-dichloro-5-fluorobiphenyl-2-yl)-3-(difluoromethyl)-1-methylpyrazole-4-carboxamide)

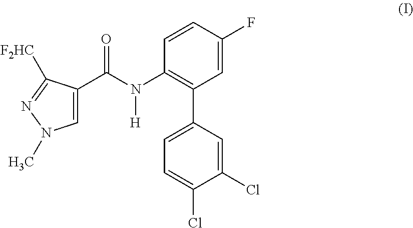

is known from WO 03/070705 and can be prepared in the manner described therein.

N-[2-(1,3-dimethylbutyl)-phenyl]-1,3-dimethyl-5-fluor-1H-pyrazole-4-carboxamide (II)

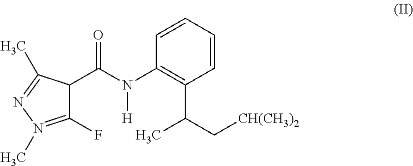

is known from WO 03/010149 and can be prepared in the manner described therein.

Fungicidal compositions of said and structurally related compounds with various other chemical compounds of different structural classes are known from WO 2005/034628 and WO 2005/041653, respectively.

However, the fungicidal performance of the known compositions against fungal pathogens in cereal plants, consisting of compound (I) or (II) and other active ingredients, are not completely satisfactory in all respects.

It has now been found that a combination comprising
a) bixafen (I) or N-[2-(1,3-dimethylbutyl)-phenyl]-1,3-dimethyl-5-fluor-1H-pyrazole-4-carboxamide (II) and
b) epoxiconazole or metconazole
   has excellent activity against harmful fungi in cereals.

The compounds (I) and (II) can be present in various crystal modifications which may differ in their biological activity. Their use also forms part of the subject matter of the present invention.

Epoxiconazole and metconazole, their preparation and their action against harmful fungi are generally known to a person skilled in the art. Both compounds are commercially available (cf., for example, www.alanwood.net/pesticides/index_cn_frame.html).

Preference is given to a combination comprising bixafen (I) and epoxiconazole or metconazole, among which epoxiconazoel is particularly preferred.

The combinations comprising
a) bixafen (I) or N-[2-(1,3-dimethylbutyl)-phenyl]-1,3-dimethyl-5-fluor-1H-pyrazole-4-carboxamide (II) and
b) epoxiconazole or metconazole
   are particularly suitable for controlling the following harmful fungi in cereals:
   Physiological leaf spots
   Ascochyta tritici
   Blumeria graminis
   Cladosporium herbarum
   Cochliobolus sativus
   Epicoccum spp.
   Erysiphe graminis
   Fusarium graminearum
   Fusarium culmorum
   Gaeumannomyces graminis
   Leptosphaeria nodorum
   Microdochium nivale
   Physiological leaf spots
   Pseudocercospora herpotrichoides
   Pseudocercosporella herpotrichoides
   Puccinia striiformis
   Puccinia triticina
   Puccinia hordei
   Puccinia recondita
   Pyrenophora graminea
   Pyrenophora teres
   Pyrenophora tritici repentis
   Ramularia collo-cygni
   Rhizoctonia solani
   Rhizoctonia cerealis
   Rhynchosporium secalis
   Septoria nodorum
   Septoria tritici
   Stagonospora nodorum
   Tilletia caries
   Typhula incarnata
   Uromyces appendiculatus
   Ustilago avenae
   Ustilago nuda

The inventive combinations are particularly suitable for controlling Physiological leaf spots, Blumeria graminis, Cochliobolus sativus, Erysiphe graminis, Fusarium graminearum, Fusarium culmorum, Gaeumannomyces graminis, Leptosphaeria nodorum, Microdochium nivale, Physiological leaf spots, Pseudocercospora herpotrichoides, Pseudocercosporella herpotrichoides, Puccinia striiformis, Puccinia triticina, Puccinia hordei, Puccinia recondita, Pyrenophora graminea, Pyrenophora teres, Pyrenophora tritici repentis, Ramularia collo-cygni, Rhizoctonia cerealis, Rhynchosporium secalis, Septoria nodorum, Septoria tritici, Stagonospora nodorum, Tilletia caries and Ustilago avenae.

The control of Blumeria graminis, Leptosphaeria nodorum, Microdochium nivale, Physiological leaf spots, Pseudocercosporella herpotrichoides, Puccinia striiformis, Puccinia triticina, Puccinia hordei, Puccinia recondita, Pyrenophora graminea, Pyrenophora teres, Pyrenophora tritici repentis, Ramularia collo-cygni, Rhizoctonia cerealis, Rhynchosporium secalis and Septoria tritici is very particularly preferred.

The cereal plants or seed treated with the combinations of
a) bixafen (I) or N-[2-(1,3-dimethylbutyl)-phenyl]-1,3-dimethyl-5-fluor-1H-pyrazole-4-carboxamide (II) and
b) epoxiconazole or metconazole
   may by wildlife types, plants or seed obtained by breeding and transgenic plants as well as their seed.

Bixafen and epoxiconazole or metconazole can be applied simultaneously, that is jointly or separately, or in succession, the sequence, in the case of separate application, generally not having any effect on the result of the control measures.

The harmful fungi are controlled by applying the combination comprising
a) bixafen (I) or N-[2-(1,3-dimethylbutyl)-phenyl]-1,3-dimethyl-5-fluor-1H-pyrazole-4-carboxamide (II) and
b) epoxiconazole or metconazole
   by treating the seed, by spraying or dusting the plants or the soil before or after sowing of the plants, or before or after emergence of the plants.

The fungal diseases in cereals are controlled advantageously by applying an aqueous preparation of a formulation comprising
a) bixafen (I) or N-[2-(1,3-dimethylbutyl)-phenyl]-1,3-dimethyl-5-fluor-1H-pyrazole-4-carboxamide (II) and
b) epoxiconazole or metconazole,
   or formulations comprising the single components, to the above-ground parts of the plants, in particular the leaves, or, as a prophylactic on account of the high systemic effectiveness, by treating the seed or the soil.

Compound (I) and epoxiconazole or metconazole respectively compound (II) and epoxiconazole or metconazole are usually applied in a weight ratio of from 100:1 to 1:100, preferably from 20:1 to 1:20, in particular from 10:1 to 1:10.

Though generally combinations of
a) bixafen (I) or N-[2-(1,3-dimethylbutyl)-phenyl]-1,3-dimethyl-5-fluor-1H-pyrazole-4-carboxamide (II) and
b) epoxiconazole or metconazole
   are employed, further compounds active against harmful fungi or other pests, such as insects, arachnids or nematodes, or else herbicidal or growth-regulating active compounds or fertilizers may be added.

Accordingly, the invention also relates to fungicidal mixtures for controlling harmful fungi in cereals, which mixtures comprise, as active components, a combination of
a) bixafen (I) or N-[2-(1,3-dimethylbutyl)-phenyl]-1,3-dimethyl-5-fluor-1H-pyrazole-4-carboxamide (II) and
b) epoxiconazole or metconazole and
c) at least one further active compound (III) as indicated above.

In the method according to the invention, the fungicidal composition can advantageously be applied together with other active compounds (III), for example herbicides, insecticides, growth regulators, further fungicides or else with fertilizers. Suitable further mixing partners of this nature are in particular:
glyphosate, sulphosate, gluphosinate, tefluthrin, terbufos, chlorpyrifos, chloroethoxyfos, tebupirimfos, phenoxycarb, diofenolan, pymetrozine, imazethapyr, imazamox, imazapyr, imazapic, imazaquin or dimethenamid-P, in particular glyphosate, sulphosate, gluphosinate or dimethenamid-P;
fipronil, imidacloprid, acetamiprid, nitenpyram, carbofuran, carbosulfan, benfuracarb, dinotefuran, thiacloprid, thiamethoxam, clothianidin, diflubenzuron, flufenoxuron, teflubenzuron, alpha-cypermethrin and metaflumizone, in particular fipronil, imidacloprid, acetamiprid, carbofuran, thiamethoxam, clothianidin, flufenoxuron, teflubenzuron, alpha-cypermethrin and metaflumizone.

Those other active compounds (III) mentioned above are usually employed in a weight ratio of from 100:1 to 1:100, preferably from 20:1 to 1:20, in particular from 10:1 to 1:10, based on the amount of compound (I) or (II).

Most preferably, the further active compound (III) is applied together with (I) or (II) and epoxiconazole or metconazole in synergistically effective amounts.

The mixtures, described above, of
a) bixafen (I) or N-[2-(1,3-dimethylbutyl)-phenyl]-1,3-dimethyl-5-fluor-1H-pyrazole-4-carboxamide (II) and
b) epoxiconazole or metconazole
   with herbicides are used in particular in crops in which the sensitivity of the plants to these herbicides, in particular glyphosate and the above mentioned imidazolinone compounds, is reduced.

When applying a combination comprising a) compound (I) or (II) and b) epoxiconazole or metconazole, to cereals, the yields are increased considerably. Thus, the combinations comprising compound (I) and epoxiconazole or metconazole respectively compound (II) and epoxiconazole or metconazole may also be used to increase the yield. By virtue of the yield increase in combination with the excellent action against harmful fungi in cereals, the method according to the invention is of particular benefit to the farmer.

The combination comprising a) compound (I) or (II) and b) epoxiconazole or metconazole, with fungicidally, insecticidally and/or herbicidally active compounds (III) is applied by treating the fungi or the plants, materials or seeds to be protected against fungal attack or the soil with a fungicidally effective amount of the active compounds. Application can be both before and after the infection of the materials or plants with the fungi.

If compound (I) or (II) is used on its own, the application rates in the method according to the invention are from 0.01 to 1.5 kg of active compound per ha, depending on the type of effect desired.

In the treatment of seed, the amounts of active compound (I) or (II) required are generally from 1 to 1500 g, preferably from 10 to 500 g, per 100 kilograms of seed.

Depending on the desired effect, the application rates of the mixtures according to the invention are from 10 g/ha to 2500 g/ha, preferably from 50 to 2000 g/ha, in particular from 100 to 1500 g/ha.

The application rates for compound (I) or (II) are generally from 1 to 1000 g/ha, preferably from 10 to 750 g/ha, in particular from 20 to 500 g/ha.

The application rates for epoxiconazole, metconazole and, if desired, the further fungicidally, insecticidally and/or herbicidally active compound (III) are generally from 1 to 1500 g/ha, preferably from 10 to 1250 g/ha, in particular from 20 to 1000 g/ha.

In the treatment of seed, application rates of combinations according to this invention are generally from 1 to 2000 g/100 kg of seed, preferably from 1 to 1500 g/100 kg, in particular from 5 to 1000 g/100 kg.

For use in the method according to the invention, the compounds can be converted into the customary formulations, for example solutions, emulsions, suspensions, dusts, powders, pastes and granules. The use form depends on the particular intended purpose; in each case, it should ensure a fine and even distribution of the compound according to the invention.

The formulations are prepared in a known manner [cf., for example, U.S. Pat. No. 3,060,084, EP-A 707 445 (liquid concentrates), Browning, “Agglomeration”, Chemical Engineering, Dec. 4, 1967, 147-48, Perry's Chemical Engineer's Handbook, 4th edition, McGraw-Hill, New York, 1963, pages 8-57, WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th edition, Blackwell Scientific Publications, Oxford, 1989 and Monet, H., Grubemann, A., Formulation technology, Wiley VCH Verlag GmbH, Weinheim (Germany), 2001, 2. D. A. Knowles, Chemistry and Technology of Agrochemical Formulations, Kluwer Academic Publishers, Dordrecht, 1998 (ISBN 0-7514-0443-8)], for example by extending the active compound with solvents and/or carriers, if desired using emulsifiers, surfactants, dispersants, stabilizers, antifoams and antifreeze agents. For formulations for treating seed, color pigments (for example rhodamine B), binders and/or swelling agents may additionally be considered.

Solvents/auxiliaries suitable for this purpose are essentially:
water, aromatic solvents (for example Solvesso® products, xylene), paraffins (for example mineral oil fractions), alcohols (for example methanol, butanol, pentanol, benzyl alcohol), ketones (for example cyclohexanone, gamma-butyrolactone), pyrrolidones (N-methylpyrrolidone, N-octylpyrrolidone), acetates (glycol diacetate), glycols, fatty acid dimethylamides, fatty acids and fatty acid esters. In principle, solvent mixtures may also be used.
carriers such as ground natural minerals (for example kaolins, clays, talc, chalk) and ground synthetic minerals (for example finely divided silicic acid, silicates); emulsifiers such as nonionogenic and anionic emulsifiers (for example polyoxyethylene fatty alcohol ethers, alkylsulfonates and arylsulfonates) and dispersants such as lignosulfite waste liquors and methylcellulose.

Suitable for use as surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone and water.

Suitable antifreeze agents are, for example, glycerol, ethylene glycol and propylene glycol.

Suitable antifoams are, for example, silicon stearates or magnesium stearates.

A suitable swelling agent is, for example, carrageen (Satiagel®).

Binders serve to improve the adhesion of the active compound or the active compounds on the seed. Suitable binders are, for example, polyethylene oxide/polypropylene oxide copolymers, polyvinyl alcohol, polyvinylpyrrolidone, poly(meth)acraylate, polybutene, polyisobutylene, polystyrene, polyethyleneamine, polyethyleneamide, polyethyleneimine (Lupasol®, Polymin®), polyethers, polyurethanes, polyvinyl acetate and the copolymers of the above polymers.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compound. The active compounds are employed in a purity of from 90% to 100%, preferably 95% to 100% (according to NMR spectrum).

For seed treatment, the formulations can be diluted 2 to 10 times, resulting in ready-to-use preparations comprising from 0.01 to 60% by weight of the active compound, preferably from 0.1 to 40% by weight of the active compound.

The following are examples of formulations: 1. Products for dilution with water

### A) Water-soluble Concentrates (SL, LS)

10 parts by weight of the active compound(s) are dissolved with 90 parts by weight of water or a water-soluble solvent. As an alternative, wetting agents or other auxiliaries are added. The active compound dissolves upon dilution with water. This gives a formulation having an active compound content of 10% by weight.

### B) Dispersible Concentrates (DC)

20 parts by weight of the active compound(s) are dissolved in 70 parts by weight of cyclohexanone with addition of 10 parts by weight of a dispersant, for example polyvinylpyrrolidone. Dilution with water gives a dispersion. The active compound content is 20% by weight.

### C) Emulsifiable Concentrates (EC)

15 parts by weight of the active compound(s) are dissolved in 75 parts by weight of xylene with addition of calcium dodecylbenzenesulfonate and castor oil ethoxylate (in each case 5 parts by weight). Dilution with water gives an emulsion. The formulation has an active compound content of 15% by weight.

### D) Emulsions (EW, EO, ES)

25 parts by weight of the active compound(s) are dissolved in 35 parts by weight of xylene with addition of calcium dodecylbenzenesulfonate and castor oil ethoxylate (in each case 5 parts by weight). This mixture is added to 30 parts by weight of water by means of an emulsifying machine (e.g. Ultraturrax) and, made into a homogeneous emulsion. Dilution with water gives an emulsion. The formulation has an active compound content of 25% by weight.

### E) Suspensions (SC, OD, FS)

In an agitated ball mill, 20 parts by weight of the active compound(s) are comminuted with addition of 10 parts by weight of dispersants and wetting agents and 70 parts by weight of water or an organic solvent to give a fine active compound suspension. Dilution with water gives a stable suspension of the active compound. The active compound content in the formulation is 20% by weight.

F) Water-Dispersible Granules and Water-Soluble Granules (WG, SG)

50 parts by weight of the active compound(s) are ground finely with addition of 50 parts by weight of dispersants and wetting agents and made into water-dispersible or water-soluble granules by means of technical appliances (for example extrusion, spray tower, fluidized bed). Dilution with water gives a stable dispersion or solution of the active compound. The formulation has an active compound content of 50% by weight.

G) Water-Dispersible Powders and Water-Soluble Powders (WP, SP, SS, WS)

75 parts by weight of the active compound(s) are ground in a rotor-stator mill with addition of 25 parts by weight of dispersants, wetting agents and silica gel. Dilution with water gives a stable dispersion or solution of the active compound. The active compound content of the formulation is 75% by weight.

### H) Gels (GF)

20 parts by weight of the active compound(s) are, with addition of 10 parts by weight of dispersants, 1 part by weight of gelling agent and 70 parts by weight of water or an organic solvent, comminuted in a bead mill to give a fine active compound suspension. Dilution with water affords a stabile suspension of the active compound. The formulation has an active compound content of 20 parts by weight.

### 2. Products To Be Applied Undiluted

### J) Dustable Powders (DP, DS)

5 parts by weight of the active compound(s) are ground finely and mixed intimately with 95 parts by weight of finely divided kaolin. This gives a dustable product with an active compound content of 5% by weight.

### K) Granules (GR, FG, GG, MG)

0.5 part by weight of the active compound(s) are ground finely and associated with 99.5 parts by weight of carriers. Current methods are extrusion, spray-drying or the fluidized bed. This gives granules with an active compound content of 0.5% by weight to be applied undiluted.

### L) ULV Solutions (UL)

10 parts by weight of the active compound(s) are dissolved in 90 parts by weight of an organic solvent, for example xylene. This gives a product with an active compound content of 10% by weight to be applied undiluted.

Suitable for seed treatment are in particular FS formulations. Typically, such an FS formulation comprises 1 to 800 g of active compound(s) per literl, 1 to 200 g of surfactant/l, 0 to 200 g of antifreeze/l, 0 to 400 g of binder/l, 0 to 200 g of color pigment/l and add 1 liter of a solvent, preferably water.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a welling agent, tackifier, dispersant or emulsifier. However, it is also possible to prepare concentrates composed of active substance, wetting agent, tackifier, dispersant or emulsifier and if appropriate, solvent or oil, with these concentrates being suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Oils of various types, wetting agents, adjuvants, herbicides, fungicides, other pesticides, or bactericides may be added to the active compounds even, if appropriate, not until immediately prior to use (tank mix). These agents are typically admixed with the compositions according to the invention in a weight ratio of from 1:100 to 100:1, preferably from 1:10 to 10:1.

### USE EXAMPLES

### A) Greenhouse

The spray solutions were prepared in several steps:

The stock solution were prepared: a mixture of acetone and/or dimethylsulfoxide and the wetting agent/emulsifier Wettol®, which is based on ethoxylated alkylphenoles, in a relation (volume) solvent-emulsifier of 99 to 1 was added to 25 mg of the compound to give a total of 10 ml.

Water was then added to total volume of 100 ml.

This stock solution was diluted with the described solvent-emulsifier-water mixture to the given concentration.

The product epoxiconazole was used as commercial finished formulation and diluted with water to the stated concentration of the active compound.

Preventative Control of Brown Rust on Wheat Caused by Puccinia recondite

The first two developed leaves of pot-grown wheat seedling were sprayed to run-off with an aqueous suspension, containing the concentration of active ingredient or their mixture as described below. The next day the plants were inoculated with spores of Puccinia recondita. To ensure the success the artificial inoculation, the plants were transferred to a humid chamber without light and a relative humidity of 95 to 99% and 20 to 22□ C. for 24 h. Then the trial plants were cultivated for 6 days in a greenhouse chamber at 22-26° C. and a relative humidity between 65 and 70%. The extent of fungal attack on the leaves was visually assessed as % diseased leaf area.

The diseases were converted into efficacies. An efficacy of 0 means that the infection level of the treated plants corresponds to that of the untreated control plants; an efficacy of 100 means that the treated plants were not infected.

The expected efficacies of active compound mixtures were determined using Colby's formula [R. S. Colby, “Calculating synergistic and antagonistic responses of herbicide combinations”, Weeds 15, 20-22 (1967)] and compared with the observed efficacies.

The visually determined percentages of infected leaf areas were converted into efficacies in % of the untreated control.

The efficacy (E) is calculated as follows using Abbot's formula:

E=(1−α/β)·100
α corresponds to the fungicidal infection of the treated plants in % and
β corresponds to the fungicidal infection of the untreated (control) plants in %

An efficacy of 0 means that the infection level of the treated plants corresponds to that of the untreated control plants; an efficacy of 100 means that the treated plants were not infected.

The expected efficacies of active compound combinations were determined using Colby's formula (Colby, S. R. “Calculating synergistic and antagonistic responses of herbicide combinations”, Weeds, 15, pp. 20-22, 1967) and compared with the observed efficacies.

### Colby's Formula:

E=x+y−x°y/100
E expected efficacy, expressed in % of the untreated control, when using the mixture of the active compounds A and B at the concentrations a and b
x efficacy, expressed in % of the untreated control, when using the active compound A at the concentration a
y efficacy, expressed in % of the untreated control, when using the active compound B at the concentration b

TABLE 1
Puccinia recondita

| | | | | Calculated |
|---|---|---|---|---|
| | | | | efficacy |
| Active compound/ | Concentration | | Observed | according |
| active combination | [ppm] | Mixture | efficacy | to Colby (%) |
| Untreated control | — | — | 90% | — |
| | | | disease | |
| Bixafen | 0.25 | — | 0 | — |
| Metconazole | 0.25 | — | 33 | — |
| Prothioconazole | 0.25 | — | 0 | — |
| Bixafen + Met- | 0.25 + 0.25 | 1:1 | 56 | 33 |
| conazole | | | | |
| Bixafen + Prothio- | 0.25 + 0.25 | 1:1 | 0 | 0 |
| conazole | | | | |

Table 1 shows that the combination comprising bixafen and metconazole exhibits strong fungicidal synergism. By contrast, the combination of bixafen and prothioconazole exhibits no synergism.

### B) Microtests

The active compounds were formulated separately as a stock solution having a concentration of 10000 ppm in dimethyl sulfoxide.

Epoxiconazole was used as commercial finished formulation and diluted with water to the stated concentration of the active compound.

B) 1. Activity against Rhizoctonia solani

The stock solutions were mixed according to the ratio, pipetted onto a micro titer plate (MTP) and diluted with water to the stated concentrations. A spore suspension of Septoria tritici in an aqueous biomalt solution was then added. The plates were placed in a water vapor-saturated chamber at a temperature of 18° C. Using an absorption photometer, the MTPs were measured at 405 nm 7 days after the inoculation.

TABLE 2
Rhizoctonia solani

| | | | | Calculated |
|---|---|---|---|---|
| | | | | efficacy |
| Active compound/ | Concentration | | Observed | according |
| active combination | [ppm] | Mixture | efficacy | to Colby (%) |
| Bixafen | 0.004 | — | 7 | — |
| | 0.001 | — | 0 | — |
| Metconazole | 0.016 | — | 62 | — |
| | 0.004 | — | 26 | — |
| Epoxiconazole | 0.004 | — | 0 | — |
| Prothioconazole | 0.016 | — | 11 | — |
| Bixafen + Met- | 0.004 + 0.016 | 1:4 | 78 | 64 |
| conazole | | | | |
| Bixafen + Met- | 0.001 + 0.004 | 1:4 | 44 | 26 |
| conazole | | | | |
| Bixafen + Epoxi- | 0.001 + 0.004 | 1:4 | 7 | 0 |
| conazole | | | | |
| Bixafen + Prothio- | 0.004 + 0.016 | 1:4 | 9 | 17 |
| conazole | | | | |

Table 2 shows that the combination comprising bixafen and metconazole exhibits strong fungicidal synergism. By contrast, the combination of bixafen and Prothioconazole exhibits no synergism.

B) 2. Activity against Septoria tritici

The stock solutions were mixed according to the ratio, pipetted onto a micro titer plate (MTP) and diluted with water to the stated concentrations. A spore suspension of Septoria tritici in an aqueous biomalt solution was then added. The plates were placed in a water vapor-saturated chamber at a temperature of 18° C. Using an absorption photometer, the MTPs were measured at 405 nm 7 days after the inoculation.

The measured parameters were compared to the growth of the active compound-free control variant (100%) and the fungus-free and active compound-free blank value to determine the relative growth in % of the pathogens in the respective active compounds. These percentages were converted into efficacies. An efficacy of 0 means that the growth level of the pathogens corresponds to that of the untreated control; an efficacy of 100 means that the pathogens were not growing.

The expected efficacies of active compound mixtures were determined using Colby's formula [R. S. Colby, “Calculating synergistic and antagonistic responses of herbicide combinations”, Weeds 15, 20-22 (1967)] and compared with the observed efficacies.

TABLE 3
Septoria tritici

| | | | | Calculated |
|---|---|---|---|---|
| | | | | efficacy |
| Active compound/ | Concentration | | Observed | according |
| active combination | [ppm] | Mixture | efficacy | to Colby (%) |
| Compound (II) | 0.004 | — | 0 | — |
| Metconazole | 0.016 | — | 19 | — |
| Prothioconazole | 0.016 | — | 5 | — |
| Compound (II) + | 0.004 + 0.016 | 1:4 | 34 | 20 |
| Metconazole | | | | |
| Compound (II) + | 0.004 + 0.016 | 1:4 | 0 | 2 |
| Prothioconazole | | | | |

Table 3 shows that the combination comprising Compound (II) and metconazole exhibits strong fungicidal synergism. By contrast, the combination of Compound (II) and prothioconazole exhibits no synergism.

1-17. (canceled)

18. A method for protecting cereals from being infected by harmful fungi, wherein the cereals, their seed or the soil is treated with a fungicidally effective amount of a synergistically active combination comprising
a) bixafen (I) or N-[2-(1,3-dimethylbutyl)-phenyl]-1,3-dimethyl-5-fluor-1H-pyrazole-4-carboxamide (II) and
b) epoxiconazole or metconazole.

19. The method according to claim 18, wherein component a) is bixafen.

20. The method according to claim 18, wherein the following fungal pathogens are controlled:
Physiological leaf spots
Ascochyta tritici
Blumeria graminis
Cladosporium herbarum
Cochliobolus sativus
Epicoccum spp.
Erysiphe graminis
Fusarium graminearum
Fusarium culmorum
Gaeumannomyces graminis
Leptosphaeria nodorum
Microdochium nivale
Physiological leaf spots
Pseudocercospora herpotrichoides
Pseudocercosporella herpotrichoides
Puccinia striiformis
Puccinia triticina
Puccinia hordei
Puccinia recondita
Pyrenophora graminea
Pyrenophora teres
Pyrenophora tritici repentis
Ramularia collo-cygni
Rhizoctonia solani
Rhizoctonia cerealis
Rhynchosporium secalis
Septoria nodorum
Septoria tritici
Stagonospora nodorum
Tilletia caries
Typhula incarnata
Uromyces appendiculatus
Ustilago avenae
Ustilago nuda

21. The method according to claim 18, wherein an aqueous preparation of a formulation comprising
a) bixafen (I) or N-[2-(1,3-dimethylbutyl)-phenyl]-1,3-dimethyl-5-fluor-1H-pyrazole-4-carboxamide (II) and
b) epoxiconazole or metconazole
is applied to the above-ground parts of the plants.

22. The method according to claim 18, wherein the harmful fungi are controlled by seed treatment or soil treatment.

23. The method according to claim 18, wherein a combination of
a) bixafen (I) or N-[2-(1,3-dimethylbutyl)-phenyl]-1,3-dimethyl-5-fluor-1H-pyrazole-4-carboxamide (II),
b) epoxiconazole or metconazole,
and at least one further, commercially available fungicide is employed.

24. The method according to claim 18, wherein a combination of
a) bixafen (I) or N-[2-(1,3-dimethylbutyl)-phenyl]-1,3-dimethyl-5-fluor-1H-pyrazole-4-carboxamide (II),
b) epoxiconazole or metconazole,
and at least one commercial herbicide which is tolerated by cereals is employed.

25. The method according to claim 18, wherein a combination of
a) bixafen (I) or N-[2-(1,3-dimethylbutyl)-phenyl]-1,3-dimethyl-5-fluor-1H-pyrazole-4-carboxamide (II),
b) epoxiconazole or metconazole,
and at least one commercial insecticide is employed.

26. The method according to claim 18, wherein a combination of
a) bixafen (I) or N-[2-(1,3-dimethylbutyl)-phenyl]-1,3-dimethyl-5-fluor-1H-pyrazole-4-carboxamide (II),
b) epoxiconazole or metconazole
and at least one active compound (III) selected from the group consisting of: glyphosate, sulphosate, gluphosinate, tefluthrin, terbufos, chlorpyrifos, chloroethoxyfos, tebupirimfos, phenoxycarb, diofenolan, pymetrozine, im-azethapyr, imazamox, imazapyr, imazapic, imazaquin, dimethenamid-P, fipronil, imidacloprid, acetamiprid, nitenpyram, carbofuran, carbosulfan, benfuracarb, dinotefuran, thiacloprid, thiamethoxam, clothianidin, diflubenz-uron, flufenoxuron, teflubenzuron, alpha-cypermethrin and metaflumizone is employed.

27. The method according to claim 23, wherein the active ingredients are applied simultaneously, that is jointly or separately, or in succession.

28. The method according to claim 23, wherein the combination is applied in an amount of from 5 g/ha to 2500 g/ha.

29. A fungicidal composition comprising, as active components,
a) bixafen (I) or N-[2-(1,3-dimethylbutyl)-phenyl]-1,3-dimethyl-5-fluor-1H-pyrazole-4-carboxamide (II),
b) epoxiconazole or metconazole and
c) glyphosate, sulphosate, gluphosinate, tefluthrin, terbufos, chlorpyrifos, chloroethoxyfos, tebupirimfos, phenoxycarb, diofenolan, pymetrozine, im-azethapyr, imazamox, imazapyr, imazapic, imazaquin or dimethenamid-P;
in a weight ratio of from 100:1 to 1:100.

30. The composition of claim 29, further comprising a liquid or solid carrier.

31. The method according to claim 18, wherein the combination comprising
a) bixafen (I) or N-[2-(1,3-dimethylbutyl)-phenyl]-1,3-dimethyl-5-fluor-1H-pyrazole-4-carboxamide (II) and
b) epoxiconazole or metconazole
is applied in an amount of from 1 to 2000 g/100 kg of seed.

32. The method according to claim 26, wherein a combination comprising
a) bixafen (I) or N-[2-(1,3-dimethylbutyl)-phenyl]-1,3-dimethyl-5-fluor-1H-pyrazole-4-carboxamide (II),
b) epoxiconazole or metconazole and
c) at least one commercially available further active compound (III) is applied in an amount of in total from 1 to 2000 g/100 kg of seed.

33. A seed comprising a fungicidal composition comprising
a) bixafen (I) or N-[2-(1,3-dimethylbutyl)-phenyl]-1,3-dimethyl-5-fluor-1H-pyrazole-4-carboxamide (II),
b) epoxiconazole or metconazole
and at least one further, commercially available fungicide, insecticide or herbicide which is tolerated by cereals in an amount of from 1 to 2000 g/100 kg.
